(19) United States
(12) Patent Application Publication
(10) Pub. No.: US 2021/0011993 A1
(43) Pub. Date: Jan. 14, 2021

(54) Device Rotational Control of Applications

(71) Applicant: ViaBlitz Inc.

(72) Inventor: Jari Kristensen, Kirkland, WA (US)

(73) Assignee: ViaBlitz Inc.

(21) Appl. No.: 16/922,834

(22) Filed: Jul. 7, 2020

Related U.S. Application Data
(60) Provisional application No. 62/871,624, filed on Jul. 8, 2019.

(51) Int. Cl. G06F 21/44; G06F 3/0346; G06F 21/84; G06F 3/0484

(52) U.S. Cl. CPC G06F 21/44; G06F 3/04845; G06F 21/84; G06F 3/0346

(57) ABSTRACT

Techniques to detect one or more rotational orientations of the device and to generate, in response to a control input, a persistent setting to cause an activation or inhibition of a function or state of one or more applications to be triggered by the one or more rotational orientations of the device.

### CROSS-REFERENCE TO RELATED APPLICATIONS

This application claims priority and benefit of U.S. Application Ser. No. 62/871,624, titled “DEVICE DISPLAY ROTATIONAL CONTROL”, filed on Jul. 8, 2019, the contents of which are incorporated herein by reference in their entirety.

### BACKGROUND

Conventional applications displayed on devices, such as mobile phones, may utilize global device settings to control display orientation. This may result in unwanted controls being asserted upon an application and inefficient use of the application.

### BRIEF SUMMARY

The present controller operates to selectively operate applications associated with a device to display content associated with a specific orientation based on a control input.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an embodiment of a system 100.

FIG. 2 depicts an embodiment of a device rotation 200.

FIG. 3 depicts an embodiment of a device rotation 300.

FIG. 4 depicts an embodiment of a device configuration routine 400.

FIG. 5 depicts a geofence hierarchy 500 in accordance with one embodiment.

FIG. 6 depicts a geofence activation system 600 in accordance with one embodiment.

FIG. 7 illustrates an authentication process 700 in accordance with one embodiment.

FIG. 8 depicts a content blitz process 800 in accordance with one embodiment.

FIG. 9 depicts a blitz activation process 900 in accordance with one embodiment.

FIG. 10 depicts a geofence activation system 1000 in accordance with one embodiment.

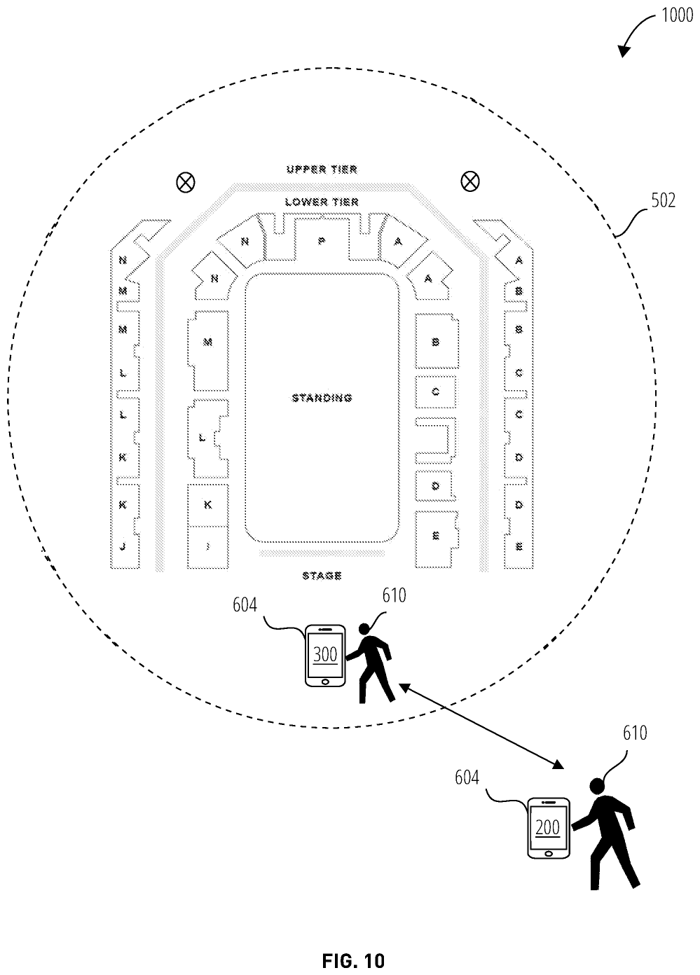

FIG. 11 depicts a display orientation control method 1100 in accordance with one embodiment.

FIG. 12 depicts a client server network configuration 1200 in accordance with one embodiment.

FIG. 13 depicts a diagrammatic representation of a machine 1300 in the form of a computer system within which a set of instructions may be executed for causing the machine to perform any one or more of the methodologies discussed herein, according to an example embodiment.

### DETAILED DESCRIPTION

Embodiments of a system and method for establishing trust of a device are disclosed, to authenticate a user's device in a geofenced area or venue through a gesture interaction with the device. For example, when a user walks into a location recognized as a geofenced area and wishes to establish trust with other devices or a system in that area, a user can perform a gesture on their personal device such as a rotational gesture, that initiates an authentication process on the user's device with other devices or systems in the geofenced area. The user's device may detect the geofenced area through positional data (e.g., GPS, etc.,), detecting wireless communication signals (e.g., Wifi, Cellular, Bluetooth, etc.,) within geofenced areas, and/or through a user interaction with a location specific element such as scanning a code within the geofenced area. The rotational gesture may invoke a changed user interface enabling authenticating of the device through an interaction. For instance, the authentication could be carried out by the user generating a pattern (e.g., a rotational pattern, or a gesture patter). An example of a rotational pattern is rotating the device two full rotations left, one quarter rotation right, and three quarters rotation left. When the pattern is recognized, the device's screen may display an updated interface enabling privileges (protected functions) and interactions with other devices or systems in the geofenced area. “Geofence” refers to a virtual geographic boundary, defined by GPS, RFID technology, etc., that enables software to trigger a response when a mobile device enters or leaves a particular area.

The interactions for the system and method for establishing trust of a device may function as a two-factor authentication process for authenticating the user's device within the geofenced area. In a two-factor authentication system, a first authentication step is established by the exchange of credentials that uniquely establish the identity of the device/user to the system where that identity carries an established trust. This allows the user to pass the first layer of authentication through the system. A second authentication step is a challenge step where additional authentication and/or trust is established through a secondary interaction.

In the system and method for establishing trust of a device, a user's device may comprise an authenticating application operating on the user's device that carries established credentials for the first authentication step with the devices or system in the geofenced area. The user may have previously logged into the application with a username and password establishing credentials with the application. When the user enters the geofenced area with their device, the application may detect the geofenced area and notify the user to rotate their device. The rotation gesture performed on the user's device may trigger the application to communicate the user's credentials to the devices and/or system within the geofenced area as the first authentication step. The devices and/or system within the geofenced area may then communicate to the user's device a secondary authentication method requesting that the user enter a code, pattern, and/or other interaction. The codes or patterns may be a pre-established code or action (e.g., a secondary “secret” comprising a pattern of gestures or interactions). In some configurations, the code or action entered by the user may be provided at the geofenced area. For instance, a code or pattern may be displayed within the geofenced area that uniquely establishes that the user is present within the location.

In some instances, the first layer of authentication may occur on the user's device but not necessarily through the authenticating application. For instance, the user may establish credentials by logging into a website on their device's browser. The device's browser may store those credential, which may then be exchanged by the authenticating application operating on the user's device when the user enters the geofenced area, and upon the user rotating their device.

In some instances, the credentials for the first layer of authentication for the user's device may be established by establishing a root trust context between the user's device and the devices or system of a defined location/area. The root trust context may be established by entering a defined location/area that then is defined as trusted context that gets saved as a trusted relationship state for the user's device and the devices and/or system associated with the defined location/area. An example of this trust interaction may take place when a user walks into a defined location/area associated with an entity (e.g., business, venue, etc.,), which may be a physically secured area, and scans a QR code with the device. This may direct the user to a website or URL associated with an entity controlling the defined location/area. Once the user is on the website or the URLs destination, they may be prompted to establish a trust relationship with the particular entity where credentials may be exchanged. By establishing the trust relationship within the defined location/area with the entity, a root trust context is established. If the user leaves the defined location/area and returns at another time, the credential from the established trust relationship may be communicated to the devices and/system within the defined location/area to reestablish the root trust context, when the user rotates their device or otherwise engages in a rotational or gestural pattern.

In some configurations, the root trust context may utilize spatiotemporal information (i.e., time and location data) from the user's device as well as information from the opened tabs within a user's devices' browser to create unique credentials for root trust. The user may utilize their device to scan a code, such as a QR code, within a particular geofence area, to start the root trust establishment process. The process may then take spatiotemporal information from the device and information from the user's devices' browser, such as the website that the user currently has opened, and utilize that information to create a unique code that may not be easily reproduced for the creation of the credentials establishing root trust.

In some configurations, additional interaction may be required before credentials are exchanged between the user's device and other devices or systems. These additional interactions may comprise an authentication step where the user rotates their device at in a specific sequence and with a specific amount of rotation at each step of the sequence. The user may, for example, rotate the device to the right at 90 degrees, then rotates the device to the left at 45 degrees, then right again a full (360 degrees) rotation, at which point an application or app of the device may recognize the rotations as a pre-established sequence that releases the credentials from their device to the other devices and/or system. Alternatively or additionally, the rotational sequence may be communicated from the device as authentication credentials (e.g., the second factor of two-factor authentication credentials) to a device or system with which to establish trust.

The specific rotation sequence to authenticate the user's device may be defined during the root trust context establishment process for a defined location/area, and used later as second-factor authentication to devices in that location/area.

In some implementations, a secondary authentication method may be established during the root trust context and utilized to authenticate the user's device on subsequent trust interactions when the user returns to a location. These secondary authentication methods may involve the user entering a code or completing a challenge, such as the aforementioned rotational pattern. The authentication application on the user's device may challenge the user with clues or prompts about the pattern and/or code. In some configurations, a ‘golden master’ of the authentication pattern is stored locally on the user's device, and in other implementations, is not stored on the user's device but is stored by the device or system the user is authenticating to. This latter approach may prevent unauthorized access to the trust relationship by unauthorized users of the user's device. In this configuration, a server associated with the devices and/or system at the defined location/area may provide the user's device with a challenge when they enter the defined location/area. The challenge may hint toward the pattern to use for authentication.

Generally, a device may be configured with logic to detect one or more rotational orientations of the device (e.g., accelerometer(s) and/or gyroscope(s) and accompanying drivers, for example). The device may typically include one or more applications (which herein should be understood to also mean apps), each of the one or more applications having at least one function or state. “Function” refers to a subset of application functionality. The device also includes logic to receive a control input (e.g., via touch screen, mouse, keyboard, microphone, etc.) and to generate, in response to the control input, a persistent setting (in a machine memory) to cause an activation or inhibition of the function or state of the one or more applications to be triggered by the one or more rotational orientations of the device.

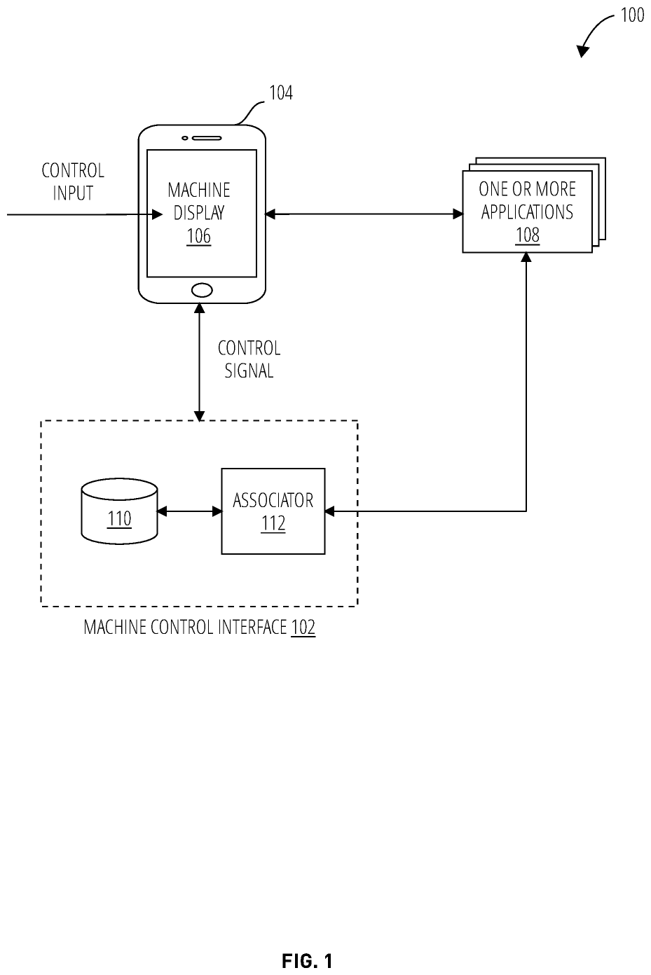

Referring to FIG. 1, a system 100 comprises a device 104, a machine display 106, a machine control interface 102, and one or more applications 108 (or apps, or combination thereof). The machine control interface 102 may further comprise an associator 112 and an association control memory structure 110.

The device 104 displays images and controls onto the machine display 106. The device may receive control signals from the one or more applications 108 to determine the contents to display onto the machine display 106. The device 104 may have stored settings in the association control memory structure 110 that affect the operation and display of the one or more applications 108. The device 104 sends a control signal to the machine control interface 102 in response to the machine display 106 receiving a control input. The device 104 may be manipulated into various orientations, for example by being rotated or undergoing translational movement. The device may determine its orientation (e.g., using gyroscopes and/or accelerometers) and display the one or more applications 108 in a display orientation in response. When the device 104 is operated to display one of the one or more applications 108, the device 104 may send a control signal to the machine control interface 102 to determine whether any associations have been generated regarding that application. The device 104 may then receive a control to alter the display and controls for that application. The device 104 may be altered to a state as a trusted agent by a combination of one or more rotations. The alteration may occur due to a rotation of the device 104, an input to the device 104, a combination of inputs and rotations, etc. As a trusted agent, the device 104 may operate to generate a firewall, or other application, to inhibit transfer of information to and from the device 104. The device 104 may further (or alternatively) generate or connect to access-controlled content available from or through another device (e.g., a Wi-Fi access point of a controlled location/area). Exemplary inputs that may be utilized in combination with patterns of rotation include a physical marker, a website URL, a thumbprint scan, etc.

The machine display 106 may display images and controls on the device 104. The machine display 106 may also receive a control input and in response operate the device 104 to send a control signal to the machine control interface 102. The control input may be an audio input, visual input, haptic input, etc. For example, the control input may be a haptic input received for a time greater than a threshold time (e.g., a “press”) or a visual image of an associated user with a time stamp for a time within a threshold of the current time. The control signal comprise instructions for the machine control interface 102 to associate the one or more applications 108 being displayed in an orientation with the orientation of the machine display 106. The orientation of the device may be utilized to determine the display of the images and controls on the machine display 106. The machine control interface 102 may also alter the display of the images and controls based on the associations generated by control signals. The control input may also alter the machine control interface 102 to de-associate one of the one or more applications 108. The machine display 106 may display additional controls for an associated application during the display of that application, which may be utilized to operate the machine control interface 102 for de-association. The control may be displayed depending on the display orientation. A control signal to de-associate one of the one or more applications 108 may also be sent when the one of the one or more applications 108 is ceased to be displayed by the machine display 106 or operation of the one of the one or more applications 108 is discontinued.

In this manner settings of the system 100 may enable the individual control or inhibition of display rotation among applications/apps. The settings may indicate the degree of rotation necessary before a particular application or app will respond by rotating it's displayed content. For example, some apps may be configured to rotate their content when the device 104 is rotated 90 degrees, whereas others will only rotate their content when the device 104 is rotated 180 degrees, and so on.

In this manner settings of the system 100 may also or alternatively enable the individual control or inhibition of functions or state among applications/apps. The settings may indicate the degree of rotation necessary before a particular application or app will respond with a state change or function, such as closing or locking the application. For example, some apps may be configured to respond when the device 104 is rotated 90 degrees, whereas others will only respond when the device 104 is rotated 180 degrees, and so on.

The machine control interface 102 receives a control signal from the device 104 and sends a control to the device 104 to operate to receive the control inputs. The machine control interface 102 may also receive information regarding the applications to which to associate the control input. In another embodiment, the machine control interface 102 receives the information from the one or more applications 108. The device 104 may send a control signal to one or more of the one or more applications 108 (e.g., the application currently being displayed) to send the information to the machine control interface 102. The machine control interface 102 may also send a control signal to the one or more of the one or more applications 108 based on the control signal to determine which of the one or more applications 108 to apply the association.

The one or more applications 108 comprise instructions to operate the device 104. The one or more applications 108 may be stored on the device 104 or may be retrieved via a network. The one or more of one or more applications 108 may generate displays on the machine display 106. The one or more applications 108 may send information regarding its operational state to the device 104 and the machine control interface 102.

The associator 112 receives a control signal from the device 104. The associator 112 may send controls to the one or more applications 108 to determine with which of the one or more applications 108 to associate a rotational operation. The associator 112 may send a control to alter the association control memory structure 110 based on the control signal or retrieve information to send to the device 104 to alter the state, display, or function of the one or more applications 108. The associator 112 may associate each of the one or more applications 108 with a rotational pattern individually, or in sets of one or more applications.

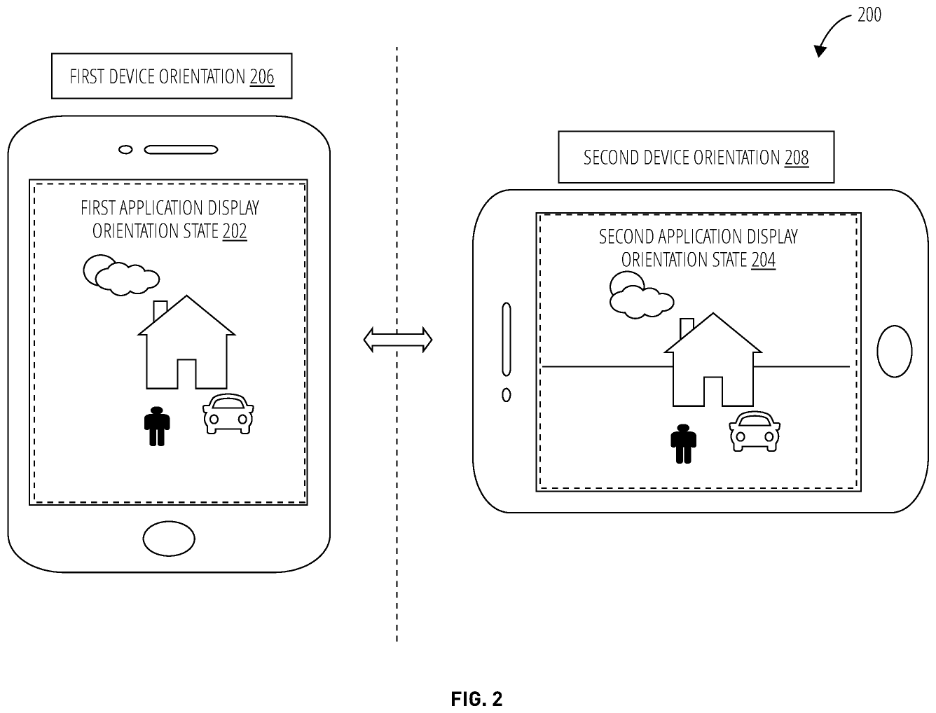

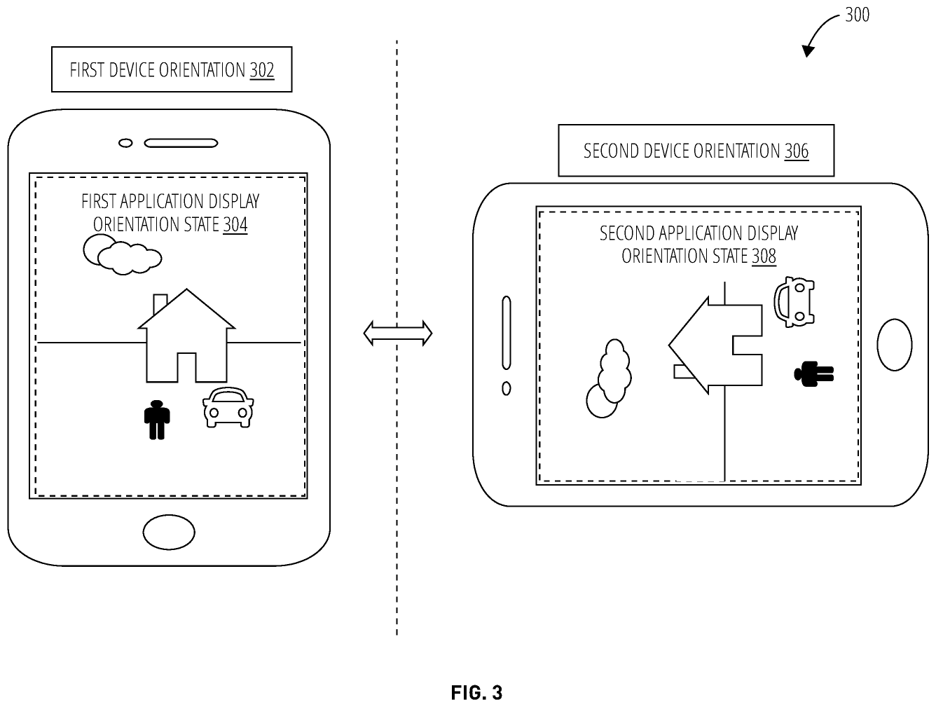

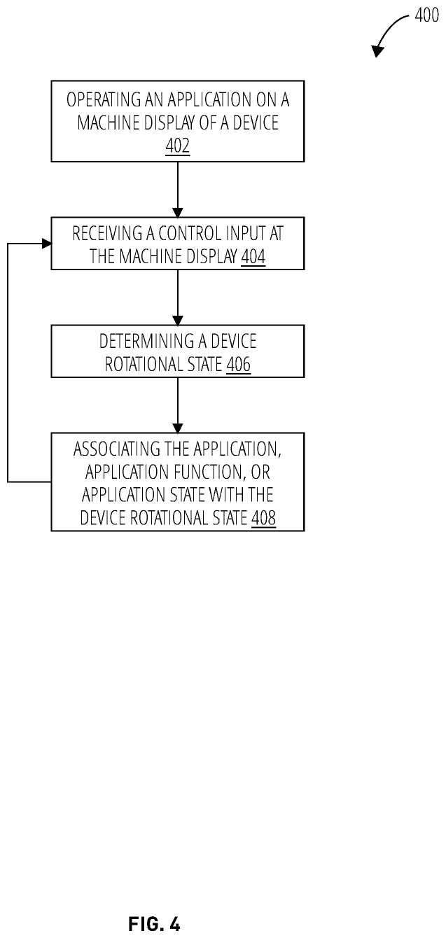

Device orientations and application display orientation states are depicted in FIG. 2 and FIG. 3. The system 100 may be operated in accordance with FIG. 4.

Referring to FIG. 2, a device rotation 200 comprises a first device orientation 206, a first application display orientation state 202, a second device orientation 208, and a second application display orientation state 204.

The device is manipulated from the first device orientation 206 to the second device orientation 208. As depicted, the device is altered by a counter-clockwise rotation from a portrait orientation to a landscape orientation. In the first device orientation 206, the first application display orientation state 202 is displayed. As depicted, the first application display orientation state 202 is a portrait display state. In the second device orientation 208, the second application display orientation state 204 is displayed. As depicted, the second application display orientation state 204 is a landscape display state. The device may receive a control input to associate the current rotational state with one or more device states or functions.

Various orientations of the device may result in one or more display states for applications (or apps) of the device. The display states may affect the operation of the applications or apps. For example, rotating the device from the first device orientation 206 to the the second device orientation 208 may trigger an application of the device to authenticate to and display content associated with a private content session established with another device.

Referring to FIG. 3, a device rotation 300 comprises a first device orientation 302, a first application display orientation state 304, a second device orientation 306, and a second application display orientation state 308.

The device may be in the first device orientation 302, resulting in the first application display orientation state 304. A control input is received by the machine display while device is in the first application display orientation state 304 and the first application display orientation state 304 of an application is displayed. The application, or a state or function of the application, is then associated with the first application display orientation state 304. When the device is manipulated to the second device orientation 306, the second application display orientation state 308 is displayed. The application, function of the application, display state, or state generally may then be associated with the application in the second device orientation 306, based on receipt of another control input.

While in any device orientation, applications, or functions or states thereof, may be associated with the device orientation in this manner. Applications may be associated individually or in groups. Applications may also be dis-associated from orientations, states, and functions in like manner.

Referring to FIG. 4, a device configuration routine 400 operates an application on a machine display of a device (block 402). The application may have plurality of states or functions based on a plurality of device orientations. A control input is received on the device, for example on the device display (block 404). The device rotational state is determined, e.g., using gyroscopes and/or accelerometers (block 406). Based on the control input, the application, or a function or state of the application, is associated with the device rotational state (block 408). The association may be applied to override the configuration of the application, a separate application that controls or cooperates with the application, the device settings, etc. A similar process may be applied to dis-associate an application, application function, or application state with a device rotational state. Likewise, for a set of active applications (or apps).

The method may further detect a geofence and enable the machine control interface to receive the control input in response to detecting the geofence. The geofence may further control whether one of the application states of functions is activated or de-activated in response to and based on device rotational state. One example of a function that may be activated for an application is second-factor authentication of the application to a private content session of a controlled location or area associated with the geofence, based on device rotational state.

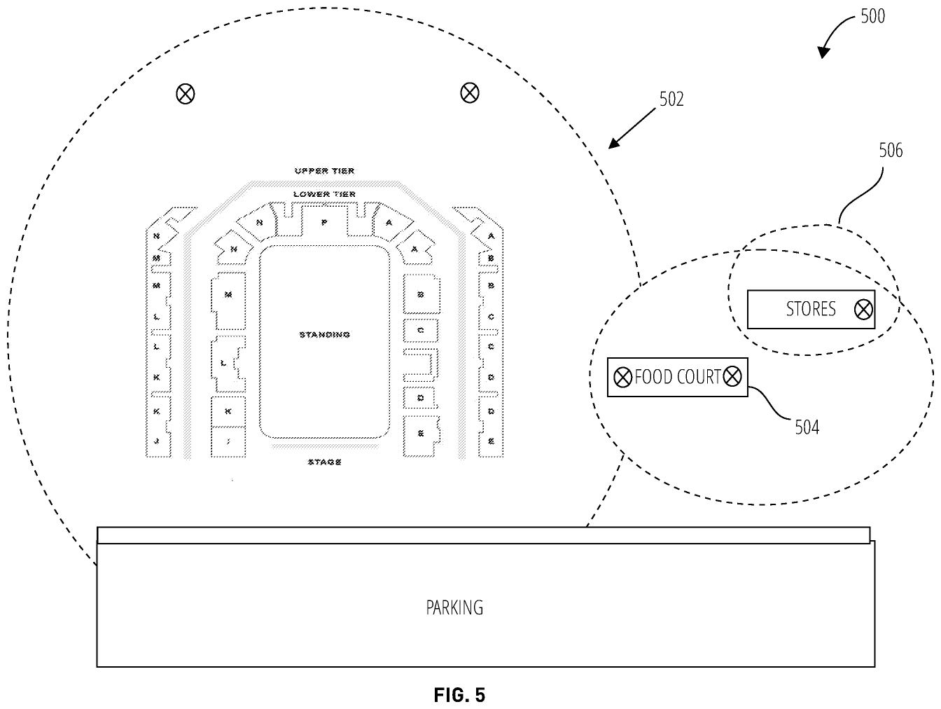

Referring to FIG. 5, a geofence hierarchy 500 comprises a geofence 502, a geofence 504, and a geofence 506. The geofence 502 and geofence 504 overlap in one area, as do the geofence 504 and the geofence 506. The geofence 506 may be considered a sub-region of the geofence 504, due to the high extent of overlap. Each geofence may enable access to private content specific to the geofence, by a device operating in a trusted capacity. Each geofence may be activated on a mobile device by entering the geofence and/or recording a marker (QR code, bar code, near field code, unique picture, etc.) with the mobile device. Markers are depicted in FIG. 5 as “X” in a circle.

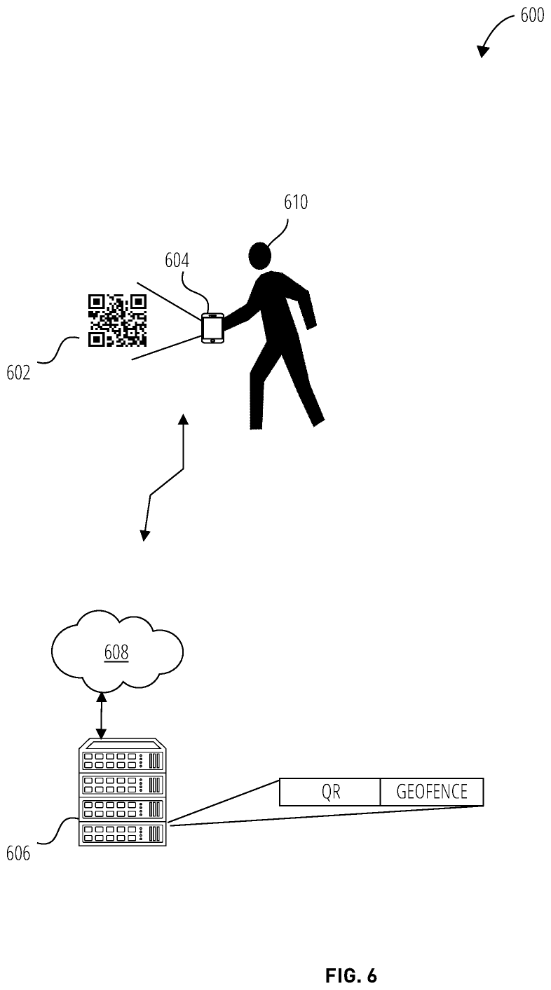

Referring now to FIG. 6, a geofence activation system 600 comprises a physical marker 602, a mobile device 604, a blitz server 606 (any private content server device or devices), and a network 608 communicatively coupling the mobile device 604 to the blitz server 606. A user 610 of the mobile device 604 takes a picture or otherwise scans (e.g., using near field or Bluetooth communication) the physical marker 602, and the mobile device 604 communicates a representation of the physical marker 602 to the blitz server 606 via the network 608. The blitz server 606 associates the physical marker 602 with a geofence, and communicates a content blitz associated with the marker to the mobile device 604. “Content blitz” refers to the downloading of an organized content set from a content server to a mobile device. The content set is organized into cells which are in turn organized into rows based on one criteria (such a similar subject matter), and columns based on a second criteria (such as a common vendor). The content blitz is associated with the geofence such that when the mobile device 604 is detected to leave or be outside the geofence, access to the content blitz is no longer enabled. In some implementations this may result in the content blitz being deleted from the mobile device 604. The mobile device 604 may be enabled a trusted device using rotational patterns to authenticate with the blitz server 606.

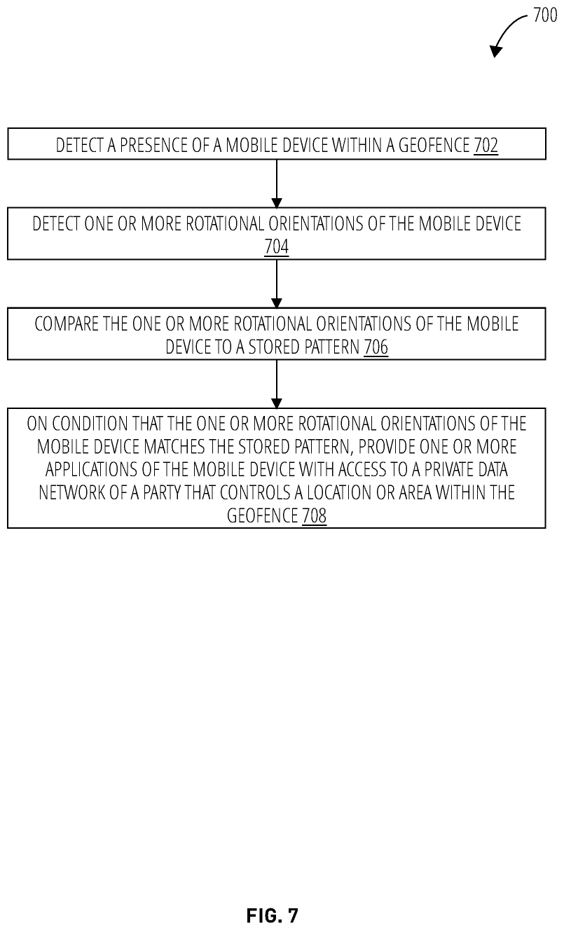

Referring now to FIG. 7, in block 702, an authentication process 700 detects a presence of a mobile device within a geofence. “Within a geofence” refers to physical location within defined boundaries of a geofence, or sufficiently close to the boundary within the resolution of location measurement technology being utilized (e.g., GPS, Wi-Fi beacons, etc.) In block 704, the authentication process 700 detects one or more rotational orientations of the mobile device. In block 706, the authentication process 700 compares the one or more rotational orientations of the mobile device to a stored pattern. In block 708, the authentication process 700 checks that the one or more rotational orientations of the mobile device matches the stored pattern, and on condition of a match, provides one or more applications of the mobile device with access to a private data network of a party that controls a location or area within the geofence. “Party that controls a location or area within the geofence” refers to a corporate, business, or individual entity that rents, owns, or otherwise controls physical access to a location or area.

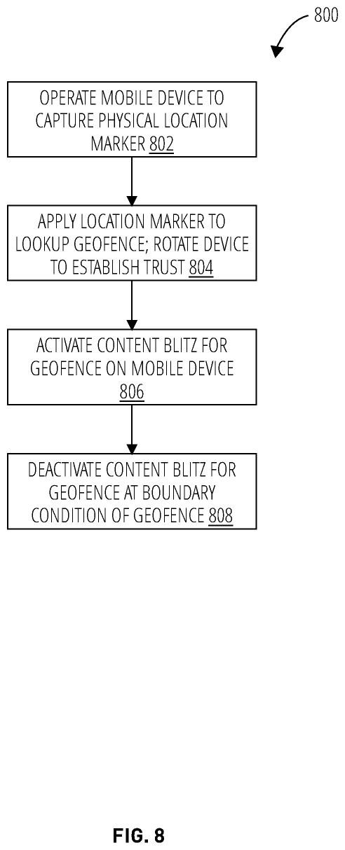

Referring to FIG. 8, at block 802, a mobile device captures a physical location marker. This marker may be a QR code, bar code, a distinctive photo, signage, or any other physical marker. In block 804, the location marker is applied to lookup a geofence associated with the marker. This may be a geofence for a venue, a retail location, an arena, etc.

In block 806, a content blitz is activated on the mobile device for the geofence. The mobile device is thus reconfigured with content, organized into conveniently manipulated cells, that is specific to the location/area associated with the geofence. The blitz remains active until the user of the mobile device deactivates it, or until a new geofence is activated (e.g., in a subregion of the larger geofence), or until an outside boundary condition of the geofence is crossed (block 808).

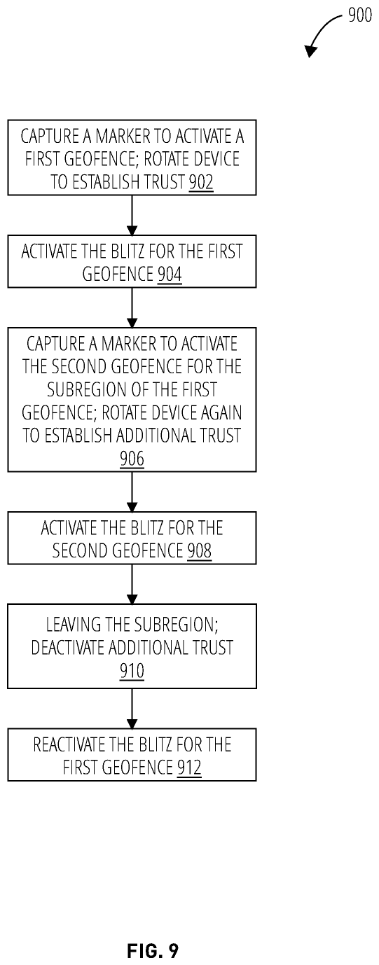

Referring now to the blitz activation process 900 of FIG. 9, to handle transitions between regions with nested subregions, first capture a marker to activate a first geofence; rotate device to establish trust 902 for the parent region and activate the blitz for the first geofence 904. Next, capture a marker to activate the second geofence for the subregion of the first geofence; rotate device again to establish additional trust 906 and activate the blitz for the second geofence 908. Next detect that the mobile device is leaving the subregion; deactivate additional trust 910 and reactivate the blitz for the first geofence 912.

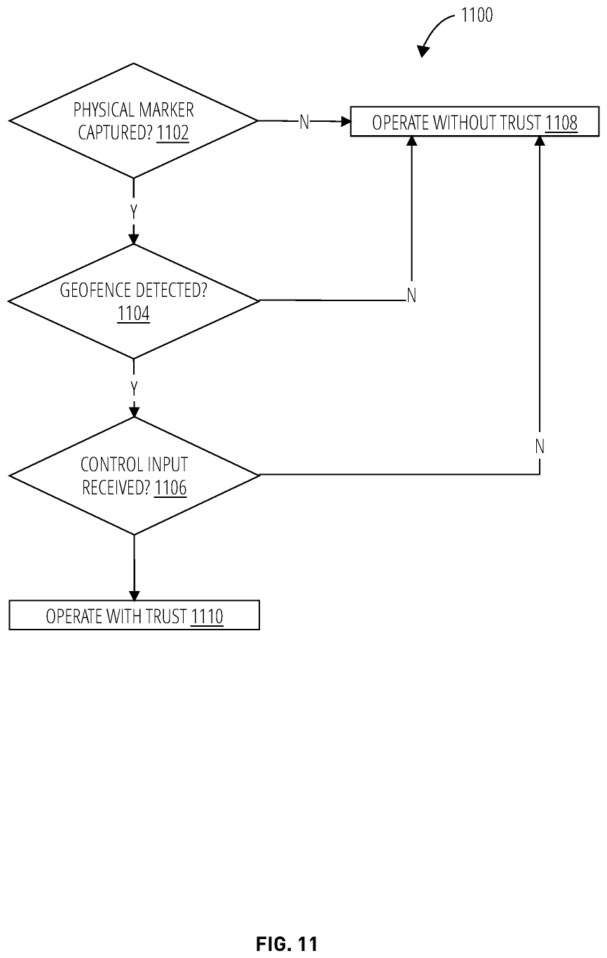

Referring to FIG. 9, a geofence activation system 1000 comprises a geofence 502, a user 610, and a mobile device 604. The mobile device 604 may detect whether it is outside of the geofence 502 or within the geofence 502. Once within the geofence 502, the user may utilize controls to operate the mobile device 604 between the device rotation 200 and the device rotation 300, for example as a second-factor authentication. The establishment of trust within the geofence 502 may be further controlled by the association of a physical marker (such as the physical marker 602). The geofence activation system 1000 may be operated according to the process depicted in FIG. 11.

Referring to FIG. 11, a display orientation control method 1100 determines whether a physical marker has been captured by a mobile device (decision block 1102). If so, the display orientation control method 1100 determines whether the associated geofence is detected (decision block 1104). If the geofence is detected, the display orientation control method 1100 determines whether a control input (e.g., a rotational pattern) has been received (decision block 1106). If the physical marker was not captured, the geofence not detected, nor the control input received, the mobile device is operated without access to content of the geofenced region to which trusted access is required (block 1108). If the physical marker was captured, the geofence detected, and the control input received, the mobile device is operated with trust to the special content (block 1110).

### Software Implementations

The systems disclosed herein, or particular components thereof, may in some embodiments be implemented using software comprising instructions executed on one or more programmable device. By way of example, components of the disclosed systems may be implemented as an application, an app, drivers, or services. In one particular embodiment, the system is implemented as an app or application that executes as one or more processes, modules, subroutines, or tasks on a mobile device so as to provide the described capabilities to one or more client devices over a network. Other embodiments may implement certain features as server-side components such as services.

By way of example, aspects of the device configuration routine 400, authentication process 700, content blitz process 800, blitz activation process 900, and/or display orientation control method 1100 may be implemented by apps, applications, drivers, or services, depending on the specific requirements of the implementation.

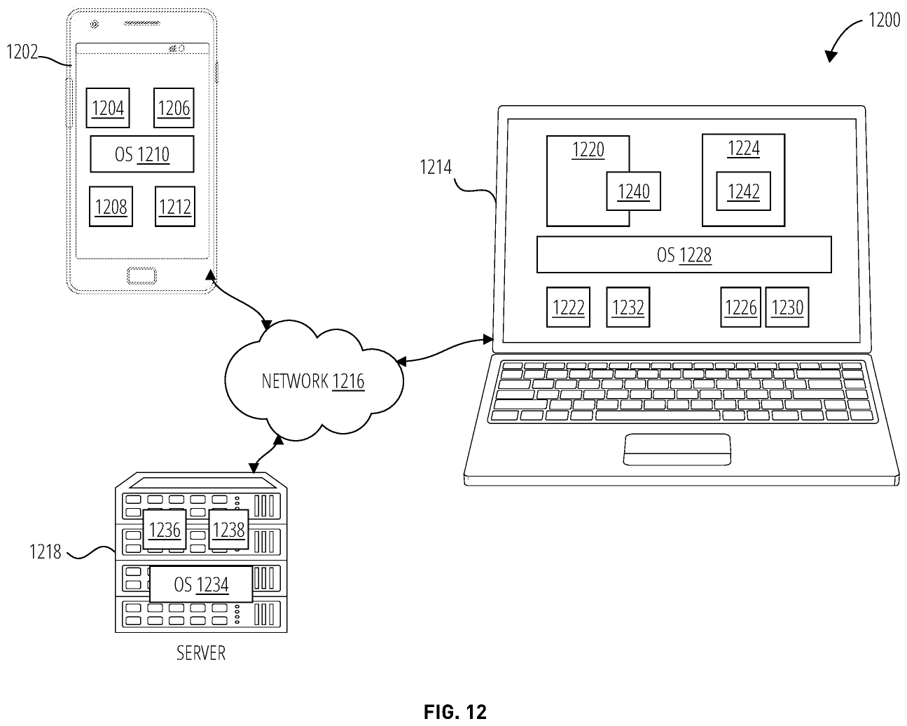

Referring to FIG. 12, a client server network configuration 1200 illustrates various computer hardware devices and software modules coupled by a network 1216 in one embodiment. Each device includes a native operating system, typically pre-installed on its non-volatile RAM, and a variety of software applications or apps for performing various functions.

The mobile programmable device 1202 comprises a native operating system 1210 and various apps (e.g., app 1204 and app 1206). A computer 1214 also includes an operating system 1228 that may include one or more library of native routines to run executable software on that device. The computer 1214 also includes various executable applications (e.g., application 1220 and application 1224). The mobile programmable device 1202 and computer 1214 are configured as clients on the network 1216. A server 1218 is also provided and includes an operating system 1234 with native routines specific to providing a service (e.g., service 1238 and service 1236) available to the networked clients in this configuration.

As is well known in the art, an application, an app, or a service may be created by first writing computer code to form a computer program, which typically comprises one or more computer code sections or modules. Computer code may comprise instructions in many forms, including source code, assembly code, object code, executable code, and machine language. Computer programs often implement mathematical functions or algorithms and may implement or utilize one or more application program interfaces.

A compiler is typically used to transform source code into object code and thereafter a linker combines object code files into an executable application, recognized by those skilled in the art as an “executable”. The distinct file comprising the executable would then be available for use by the computer 1214, mobile programmable device 1202, and/or server 1218. Any of these devices may employ a loader to place the executable and any associated library in memory for execution. The operating system executes the program by passing control to the loaded program code, creating a task or process. An alternate means of executing an application or app involves the use of an interpreter (e.g., interpreter 1242).

In addition to executing applications (“apps”) and services, the operating system is also typically employed to execute drivers to perform common tasks such as connecting to third-party hardware devices (e.g., printers, displays, input devices), storing data, interpreting commands, and extending the capabilities of applications. For example, a driver 1208 or driver 1212 on the mobile programmable device 1202 or computer 1214 (e.g., driver 1222 and driver 1232) might enable wireless headphones to be used for audio output(s) and a camera to be used for video inputs. Any of the devices may read and write data from and to files (e.g., file 1226 or file 1230) and applications or apps may utilize one or more plug-in (e.g., plug-in 1240) to extend their capabilities (e.g., to encode or decode video files).

The network 1216 in the client server network configuration 1200 can be of a type understood by those skilled in the art, including a Local Area Network (LAN), Wide Area Network (WAN), Transmission Communication Protocol/Internet Protocol (TCP/IP) network, and so forth. These protocols used by the network 1216 dictate the mechanisms by which data is exchanged between devices.

### Machine Embodiments

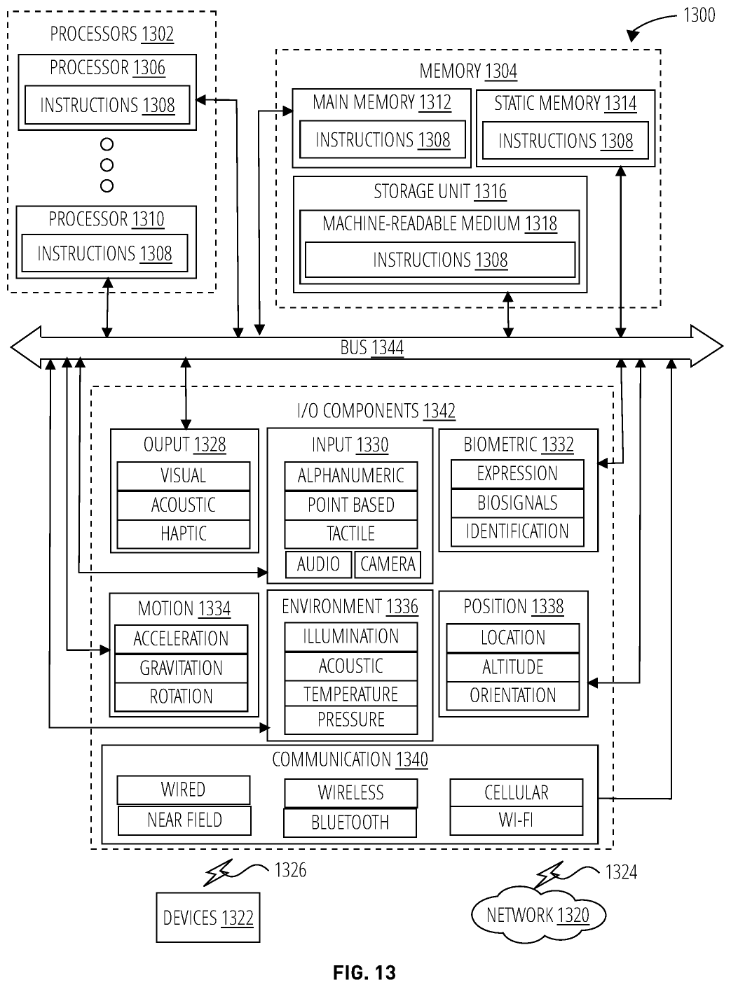

FIG. 13 depicts a diagrammatic representation of a machine 1300 in the form of a computer system within which logic may be implemented to cause the machine to perform any one or more of the functions or methods disclosed herein, according to an example embodiment.

Specifically, FIG. 13 depicts a machine 1300 comprising instructions 1308 (e.g., a program, an application, an applet, an app, or other executable code) for causing the machine 1300 to perform any one or more of the functions or methods discussed herein. For example the instructions 1308 may cause the machine 1300 to carry out aspects of the device configuration routine 400, authentication process 700, content blitz process 800, blitz activation process 900, and/or display orientation control method 1100. The instructions 1308 configure a general, non-programmed machine into a particular machine 1300 programmed to carry out said functions and/or methods.

In alternative embodiments, the machine 1300 operates as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1308, sequentially or otherwise, that specify actions to be taken by the machine 1300. Further, while only a single machine 1300 is depicted, the term “machine” shall also be taken to include a collection of machines that individually or jointly execute the instructions 1308 to perform any one or more of the methodologies or subsets thereof discussed herein.

The machine 1300 may include processors 1302, memory 1304, and I/O components 1342, which may be configured to communicate with each other such as via one or more bus 1344. In an example embodiment, the processors 1302 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, one or more processor (e.g., processor 1306 and processor 1310) to execute the instructions 1308. The term “processor” is intended to include multi-core processors that may comprise two or more independent processors (sometimes referred to as “cores”) that may execute instructions contemporaneously. Although FIG. 13 depicts multiple processors 1302, the machine 1300 may include a single processor with a single core, a single processor with multiple cores (e.g., a multi-core processor), multiple processors with a single core, multiple processors with multiples cores, or any combination thereof.

The memory 1304 may include one or more of a main memory 1312, a static memory 1314, and a storage unit 1316, each accessible to the processors 1302 such as via the bus 1344. The main memory 1312, the static memory 1314, and storage unit 1316 may be utilized, individually or in combination, to store the instructions 1308 embodying any one or more of the functionality described herein. The instructions 1308 may reside, completely or partially, within the main memory 1312, within the static memory 1314, within a machine-readable medium 1318 within the storage unit 1316, within at least one of the processors 1302 (e.g., within the processor's cache memory), or any suitable combination thereof, during execution thereof by the machine 1300.

The I/O components 1342 may include a wide variety of components to receive input, provide output, produce output, transmit information, exchange information, capture measurements, and so on. The specific I/O components 1342 that are included in a particular machine will depend on the type of machine. For example, portable machines such as mobile phones will likely include a touch input device or other such input mechanisms, while a headless server machine will likely not include such a touch input device. It will be appreciated that the I/O components 1342 may include many other components that are not shown in FIG. 13. The I/O components 1342 are grouped according to functionality merely for simplifying the following discussion and the grouping is in no way limiting. In various example embodiments, the I/O components 1342 may include output components 1328 and input components 1330. The output components 1328 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1330 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), one or more cameras for capturing still images and video, and the like.

In further example embodiments, the I/O components 1342 may include biometric components 1332, motion components 1334, environmental components 1336, or position components 1338, among a wide array of possibilities. For example, the biometric components 1332 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 1334 may include acceleration sensor components (e.g., accelerometer), gravitation sensor components, rotation sensor components (e.g., gyroscope), and so forth. The environmental components 1336 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1338 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1342 may include communication components 1340 operable to couple the machine 1300 to a network 1320 or devices 1322 via a coupling 1324 and a coupling 1326, respectively. For example, the communication components 1340 may include a network interface component or another suitable device to interface with the network 1320. In further examples, the communication components 1340 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 1322 may be another machine or any of a wide variety of peripheral devices (e.g., a peripheral device coupled via a USB).

Moreover, the communication components 1340 may detect identifiers or include components operable to detect identifiers. For example, the communication components 1340 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1340, such as location via Internet Protocol (IP) geolocation, location via Wi-Fi® signal triangulation, location via detecting an NFC beacon signal that may indicate a particular location, and so forth.

### Instruction and Data Storage Medium Embodiments

The various memories (i.e., memory 1304, main memory 1312, static memory 1314, and/or memory of the processors 1302) and/or storage unit 1316 may store one or more sets of instructions and data structures (e.g., software) embodying or utilized by any one or more of the methodologies or functions described herein. These instructions (e.g., the instructions 1308), when executed by processors 1302, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors and internal or external to computer systems. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such intangible media, at least some of which are covered under the term “signal medium” discussed below.

### Communication Network Embodiments

In various example embodiments, one or more portions of the network 1320 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1320 or a portion of the network 1320 may include a wireless or cellular network, and the coupling 1324 may be a Code Division Multiple Access (CDMA) connection, a Global System for Mobile communications (GSM) connection, or another type of cellular or wireless coupling. In this example, the coupling 1324 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1308 and/or data generated by or received and processed by the instructions 1308 may be transmitted or received over the network 1320 using a transmission medium via a network interface device (e.g., a network interface component included in the communication components 1340) and utilizing any one of a number of well-known transfer protocols (e.g., hypertext transfer protocol (HTTP)). Similarly, the instructions 1308 may be transmitted or received using a transmission medium via the coupling 1326 (e.g., a peer-to-peer coupling) to the devices 1322. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1308 for execution by the machine 1300, and/or data generated by execution of the instructions 1308, and/or data to be operated on during execution of the instructions 1308, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### LISTING OF DRAWING ELEMENTS

100 system
102 machine control interface
104 device
106 machine display
108 one or more applications
110 association control memory structure
112 associator
200 device rotation
202 first application display orientation state
204 second application display orientation state
206 first device orientation
208 second device orientation
300 device rotation
302 first device orientation
304 first application display orientation state
306 second device orientation
308 second application display orientation state
400 device configuration routine
402 block
404 block
406 block
408 block
500 geofence hierarchy
502 geofence
504 geofence
506 geofence
600 geofence activation system
602 physical marker
604 mobile device
606 blitz server
608 network
610 user
700 authentication process
702 block
704 block
706 block
708 block
800 content blitz process
802 block
804 block
806 block
808 block
900 blitz activation process
902 capture a marker to activate a first geofence; rotate device to establish trust
904 activate the blitz for the first geofence
906 capture a marker to activate the second geofence for the subregion of the first geofence; rotate device again to establish additional trust
908 activate the blitz for the second geofence
910 leaving the subregion; deactivate additional trust
912 reactivate the blitz for the first geofence
1000 geofence activation system
1100 display orientation control method
1102 decision block
1104 decision block
1106 decision block
1108 block
1110 block
1200 client server network configuration
1202 mobile programmable device
1204 app
1206 app
1208 driver
1210 operating system
1212 driver
1214 computer
1216 network
1218 server
1220 application
1222 driver
1224 application
1226 file
1228 operating system
1230 file
1232 driver
1234 operating system
1236 service
1238 service
1240 plug-in
1242 interpreter
1300 machine
1302 processors
1304 memory
1306 processor
1308 instructions
1310 processor
1312 main memory
1314 static memory
1316 storage unit
1318 machine-readable medium
1320 network
1322 devices
1324 coupling
1326 coupling
1328 output components
1330 input components
1332 biometric components
1334 motion components
1336 environmental components
1338 position components
1340 communication components
1342 I/O components
1344 bus

### Terminology

“Algorithm” refers to any set of instructions configured to cause a machine to carry out a particular function or process.

“App” refers to a type of application with limited functionality, most commonly associated with applications executed on mobile devices. Apps tend to have a more limited feature set and simpler user interface than applications as those terms are commonly understood in the art.

“Application” refers to any software that is executed on a device above a level of the operating system. An application will typically be loaded by the operating system for execution and will make function calls to the operating system for lower-level services. An application often has a user interface but this is not always the case. Therefore, the term ‘application’ includes background processes that execute at a higher level than the operating system.

“Application program interface” refers to instructions implementing entry points and return values to a module.

“Assembly code” refers to a low-level source code language comprising a strong correspondence between the source code statements and machine language instructions. Assembly code is converted into executable code by an assembler. The conversion process is referred to as assembly. Assembly language usually has one statement per machine language instruction, but comments and statements that are assembler directives, macros, and symbolic labels may also be supported.

“Compiled computer code” refers to object code or executable code derived by executing a source code compiler and/or subsequent tools such as a linker or loader.

“Compiler” refers to logic that transforms source code from a high-level programming language into object code or in some cases, into executable code.

“Computer code” refers to any of source code, object code, or executable code.

“Computer code section” refers to one or more instructions.

“Computer program” refers to another term for ‘application’ or ‘app’.

“Driver” refers to low-level logic, typically software, that controls components of a device. Drivers often control the interface between an operating system or application and input/output components or peripherals of a device, for example.

“Executable” refers to a file comprising executable code. If the executable code is not interpreted computer code, a loader is typically used to load the executable for execution by a programmable device.

“Executable code” refers to instructions in a ready-to-execute form by a programmable device. For example, source code instructions in non-interpreted execution environments are not executable code because they must usually first undergo compilation, linking, and loading by the operating system before they have the proper form for execution. Interpreted computer code may be considered executable code because it can be directly applied to a programmable device (an interpreter) for execution, even though the interpreter itself may further transform the interpreted computer code into machine language instructions.

“File” refers to a unitary package for storing, retrieving, and communicating data and/or instructions. A file is distinguished from other types of packaging by having associated management metadata utilized by the operating system to identify, characterize, and access the file.

“Instructions” refers to symbols representing commands for execution by a device using a processor, microprocessor, controller, interpreter, or other programmable logic. Broadly, ‘instructions’ can mean source code, object code, and executable code. ‘instructions’ herein is also meant to include commands embodied in programmable read-only memories (EPROM) or hard coded into hardware (e.g., ‘micro-code’) and like implementations wherein the instructions are configured into a machine memory or other hardware component at manufacturing time of a device.

“Interpreted computer code” refers to instructions in a form suitable for execution by an interpreter.

“Interpreter” refers to an interpreter is logic that directly executes instructions written in a source code scripting language, without requiring the instructions to a priori be compiled into machine language. An interpreter translates the instructions into another form, for example into machine language, or into calls to internal functions and/or calls to functions in other software modules.

“Library” refers to a collection of modules organized such that the functionality of all the modules may be included for use by software using references to the library in source code.

“Linker” refers to logic that inputs one or more object code files generated by a compiler or an assembler and combines them into a single executable, library, or other unified object code output. One implementation of a linker directs its output directly to machine memory as executable code (performing the function of a loader as well).

“Loader” refers to logic for loading programs and libraries. The loader is typically implemented by the operating system. A typical loader copies an executable into memory and prepares it for execution by performing certain transformations, such as on memory addresses.

“Machine language” refers to instructions in a form that is directly executable by a programmable device without further translation by a compiler, interpreter, or assembler. In digital devices, machine language instructions are typically sequences of ones and zeros.

“Module” refers to a computer code section having defined entry and exit points. Examples of modules are any software comprising an application program interface, drivers, libraries, functions, and subroutines.

“Object code” refers to the computer code output by a compiler or as an intermediate output of an interpreter. Object code often takes the form of machine language or an intermediate language such as register transfer language (RTL).

“Operating system” refers to logic, typically software, that supports a device's basic functions, such as scheduling tasks, managing files, executing applications, and interacting with peripheral devices. In normal parlance, an application is said to execute “above” the operating system, meaning that the operating system is necessary in order to load and execute the application and the application relies on modules of the operating system in most cases, not vice-versa. The operating system also typically intermediates between applications and drivers. Drivers are said to execute “below” the operating system because they intermediate between the operating system and hardware components or peripheral devices.

“Plug-in” refers to software that adds features to an existing computer program without rebuilding (e.g., changing or re-compiling) the computer program. Plug-ins are commonly used for example with Internet browser applications.

“Process” refers to software that is in the process of being executed on a device.

“Programmable device” refers to any logic (including hardware and software logic) who's operational behavior is configurable with instructions.

“Service” refers to a process configurable with one or more associated policies for use of the process. Services are commonly invoked on server devices by client devices, usually over a machine communication network such as the Internet. Many instances of a service may execute as different processes, each configured with a different or the same policies, each for a different client.

“Software” refers to logic implemented as instructions for controlling a programmable device or component of a device (e.g., a programmable processor, controller). Software can be source code, object code, executable code, machine language code. Unless otherwise indicated by context, software shall be understood to mean the embodiment of said code in a machine memory or hardware component, including “firmware” and micro-code.

“Source code” refers to a high-level textual computer language that requires either interpretation or compilation in order to be executed by a device.

“Subroutine” refers to a module configured to perform one or more calculations or other processes. In some contexts the term ‘subroutine’ refers to a module that does not return a value to the logic that invokes it, whereas a ‘function’ returns a value. However herein the term ‘subroutine’ is used synonymously with ‘function’.

“Task” refers to one or more operations that a process performs.

Various functional operations described herein may be implemented in logic that is referred to using a noun or noun phrase reflecting said operation or function. For example, an association operation may be carried out by an “Associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C. § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

1. A device comprising:
a first top controller for a system-on-a-chip;
a second top controller for a graphics processing unit;
the first top controller to retrieve test patterns for the second top controller from a test pattern storage memory, and to receive the test results from the second top controller;
the system-on-a-chip comprising a first plurality of functional logic blocks;
the graphics processing unit comprising a second plurality of functional logic blocks;
each of the functional logic blocks comprising a scan chain;
a plurality of first logic block controllers each associated with one or more of the first plurality of functional logic blocks and coordinated by the first top controller;
a plurality of second logic block controllers each associated with one or more of the second plurality of functional logic blocks and coordinated by the second top controller;
test logic to operate each top controller to load test patterns to the associated logic block controllers and to write test results back to the associated top controller after execution of the test patterns by the associated logic block controllers, the test patterns and test results both encoded in packet format; and
each logic block controller decoding and applying the test patterns to an associated scan chain.

2. (canceled)

3. The device of claim 1, each of the logic block controllers comprising a deserializer to deserialize the test patterns into deserialized test patterns, a sequential decompressor to apply the deserialized test patterns to the scan chain of a logic block, and a sequential compressor to compress test results from the logic block into a test results shift register.

4. The device of claim 3, further comprising:
an ideal test results shift register associated with the test results shift register;
a comparator; and
a status register to receive a result of comparing contents of the test results shift register and the ideal test results shift register.

5. The device of claim 1, each top controller comprising:
a JTAG interface to a packet data write controller; and
a JTAG interface to a status data read controller.

6. The device of claim 5, each top controller further comprising:
a packet write buffer to receive test pattern packets;
a packet data forwarding unit; and
a packet data link multiplexer to distribute the test pattern packets to the logic block controllers.

7. The device of claim 6, each top controller further comprising:
a packet data read and decode unit and a packet data link controller to coordinate between the packet write buffer and the packet data forwarding unit.

8. The device of claim 1, each top controller comprising:
a status data link demultiplexer to receive test results from the logic block controllers;
a status write buffer; and
a status arbitration unit to coordinate the status link demultiplexer and the status write buffer.

9. The device of claim 1, each of the logic block controllers comprising:
a packet data write controller to receive test pattern packets;
a packet write buffer;
a packet data serializer; and
a packet data control sequencer to distribute the test pattern packets to the functional logic blocks.

10. The device of claim 1, further comprising analytical logic configured to ignore test result packets corresponding to non-functional regions of the device.

11. A method comprising:
operating a first top controller to load first test patterns to a first plurality of logic block controllers of a system on a chip;
passing second test patterns from the first top controller to a second top controller of a graphics processing unit;
operating the second top controller to load the second test patterns to a second plurality of logic block controllers of the graphics processing unit;
the respective logic block controllers writing test results back to the respective top controllers after execution of the test patterns by the logic block controllers, the test patterns and test results both encoded in packet format;
the second top controller writing test results back to the first top controller; and
each logic block controller decoding and applying the test patterns to an associated scan chain.

12. (canceled)

13. The method of claim 11, further comprising:
operating a deserializer of each of the logic block controllers to deserialize the test patterns into deserialized test patterns;
operating a sequential decompressor of each of the logic block controllers to apply the deserialized test patterns to the scan chain of a logic block; and
operating a sequential compressor of each of the logic block controllers to compress test results from the logic block into a test results shift register.

14. The method of claim 13, further comprising:
associating an ideal test results shift register with the test results shift register;
providing a status register to receive a result of comparing contents of the test results shift register and the ideal test results shift register.

15. The method of claim 11, each top controller comprising:
a JTAG interface to a packet data write controller; and
a JTAG interface to a status data read controller.

16. The method of claim 15, each top controller further comprising:
a packet write buffer to receive test pattern packets;
a packet data forwarding unit; and
a packet data link multiplexer to distribute the test pattern packets to the logic block controllers.

17. The method of claim 16, each top controller further comprising:
a packet data read and decode unit and a packet data link controller to coordinate between the packet write buffer and the packet data forwarding unit.

18. The method of claim 11, each top controller comprising:
a status data link demultiplexer to receive test results from the logic block controllers;
a status write buffer; and
a status arbitration unit to coordinate the status link demultiplexer and the status write buffer.

19. The method of claim 11, each of the logic block controllers comprising:
a packet data write controller to receive test pattern packets;
a packet write buffer;
a packet data serializer; and
a packet data control sequencer to distribute the test pattern packets to functional logic blocks associated with the plurality of logic block controllers.

20. The method of claim 11, further comprising analytical logic configured to ignore test result packets corresponding to non-functional logic blocks associated with the plurality of logic block controllers.
